(19) United States
(12) Patent Application Publication
(10) Pub. No.: US 2006/0166939 A1
(43) Pub. Date: Jul. 27, 2006

(54) Fertilizer-compatible composition

(76) Inventor: Chi-Yu R. Chen, Liberty, MO (US)

Correspondence Address: BAYER CROPSCIENCE LP;Patent Department, 100 BAYER ROAD, PITTSBURGH, PA, 15205-9741, US

(21) Appl. No.: 11/041,167

(22) Filed: Jan. 21, 2005

(51) Int. Cl. A01N 43/66; A01N 57/00; A01N 43/54; A01N 43/40; A01N 43/78

(52) U.S. Cl. 514/91; 514/229.2; 514/226.8; 514/241; 514/341; 514/357; 514/365; 514/256; 514/343; 514/340

(57) ABSTRACT

This invention relates to pesticidal compositions compatible with liquid fertilizers and methods of use thereof.

The present invention relates to compositions for use in agricultural and non-agricultural pest control applications.

Many pesticide formulations are tank-mixed as liquids in the field with many other pesiticides, adjuvants and the like to maximize application efficiency. Many tank mixtures include two or more pesticides and/or fertilizers.

Compatibility of fertilizers with pesticides in tank-mixtures has proved a persistently troublesome problem. Despite the years of research, there is no general solution to the incompatibility problem, although earlier practitioners have provided several proposed solutions, e.g., U.S. Pat. Nos. 4,464,193, 5,516,747, and 4,071,617.

A major challenge lies in the unpredictability and complex nature of the final tank-mixtures. There are two general types of incompatibility of pesticides and fertilizers: chemical and physical. For example chemical incompatibility of a pesticide and fertilizer occurs when a pesticide is hydrolyzed or subjected to other unwanted chemical reactions. Physical incompatibility occurs most frequently when the tank mixture forms an agglomerate due to, e.g., coagulation, flocculation, gelling, or precipitation of crystals. The mixtures may form hard packed agglomerates or oil globules. Physical incompatibility present difficulties since the malfunctioning tank-mixture plugs conventional spray filters and nozzles.

The problem can be persistent despite the use of compatibility agents which mostly are organic nonionic surfactants. Between the two incompatibility types, the physical incompatibility is the most serious of all, since chemical incompatibility can be generally avoided beforehand. Physical incompatibility is generally overcome by use of surfactants or wetting agents and dispersants. Although there have been pesticide suspension patents of fertilizer compatible compositions as described above, they are found to suffer from one major problem, foaming. This can be a persistent problem during tank mixing with fertilizers, apparently caused by the presence of surfactant combinations. As a result, the foaming problem can lead to inaccurate spray volume of the fertilizer mix.

The chloronicontinyl insecticides are known as effective insecticides in agricultural and non-agricultural pest control. However, a known problem of this class of insecticides and other pesticides in general is the compatibility of the pesticides with fertilizers, particularly liquid fertilizer compositions.

The present invention provides a fluid thixotropic composition comprising:
(a) a compound of formula (I) 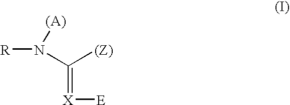
   wherein
   R is hydrogen, acyl, alkyl, aryl, aralkyl, heteroaryl or heteroarylalkyl;
   A is hydrogen, acyl, alkyl, aryl, or a bifunctional group which is linked to Z;
   E is NO₂, CN, or a halogenoalkylcarbonyl group;
   X is —CR′═or ═N—, wherein R′ is hydrogen or a bifunctional group linked to Z;
   Z is alkyl, —OR″, —SR″, —NR″R″ or Z is a group linked to (i) the radical A; or (ii) the radical X or (iii) both A and X;
   provided that when E is CN, Z is not methyl and R is not a (6-chloro-3-pyridyl)methyl 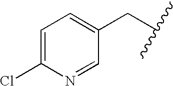
      radical;
(b) a metal lignosulfate salt;
(c) a water soluble salt of a strong acid; and
(d) water;
   wherein the compound is in the form of particles of sufficiently small average diameter to be effectively dispersed in the composition and wherein the metal lignosulfate salt and water soluble salt are combined in amounts effective to disperse the particles in the water.

The metal lignosulfate salt may be any salt of a lignosulfonic acid which is effective to disperse the insecticide. Typical metal counterions include sodium, potassium, lithium, and calcium. Two or more lignosulfate salts may be combined in effective amounts to provide an adequate dispersant. For example, sodium lignosulftate and calcium lignosulfate may be combined in effective amounts.

Should it be necessary, an ammonium lignosulfate salt may be used, e.g. a tetraalkyl ammonium or aryltrialkylammonium counterion may be used. Examples of these types of dispersants include tetrabutyl ammonium lignosulfate and phenyltrimethylammonium lignosulfate.

The composition of the invention is generally a controlled flocculation. In general, the composition is substantially a thixotropic suspension. If the average diameter of the particles of the compound is from 1 nm to 0.5 microns then the suspension is colloidal; if the average diameter of the particles is from 0.5 microns to 100 microns, then the suspension is a coarse suspension. Ideally the particles are of average diameter of from about 1 micron to about 10 microns.

The lignosulfate anion moiety of the metal lignosulfate salt is generally a product of the sulfonation of lignin. The anion may comprise polymeric molecules of weight-average molecular weight from about 2000 to 100000 g/mol (Daltons). A preferred molecular weight range is between 1000 and 80,000, more preferably from 2000 to 60000 with carbon to sulfur ratio between 9:1 to 55:1. A preferred molecular weight range is from 20000 to 30000, and a number average molecular weight of from about 1000 to about 10000 g/mol. More preferably, the molecular weight of the metal lignosulfate salt is from 2000 g/mol to about 8000 g/mol. Examples of these types of lignosulfonic acid salts include Borresperse® NA sodium lignosulfonate dispersant, Borresperse®O CA calcium lignosulfate dispersant, Ultrazine® NA sodium lignosulfonate dispersant and Ultrazine®CA calcium lignosulfate dispersant. All of these dispersants are available from the Borregaard® Lignotech Company (Internet: http//:www.lignotech.com) at Borregaard P.O. Box 162 NO-1 701 Sarpsborg, Norway.

The metal content of the metal lignosulfate is generally from 0.2% to 15% by weight if sodium or from 0.1 to 0.9% if calcium. The amount of sulfonation of the lignin polymer is generally from 2 to 10% by weight. The degree of sulfonation is generally from 0.5% to 3%.

Generally, one or more of the following types of lignin-based dispersants may be used: mono-calcium salt of polymerized aryl alkylsulfonic acids,(Lignosulfonate calcium salt); Sodium salt of kraft lignin polymer optionally mixed with a modified sulfite lignin; Ammonium lignosulfonates; lignin, alkali, reaction product with sodium bisulfite and formaldehyde.

Metal lignosulfate salts are materials that may be prepared from the waste liquor of sulfite pulping. Then they are further oxidized, or desulfonated. Generally, lignin sulfonates are water soluble polymers carrying ionic charge along the backbone chain, including ammonium, sodium, calcium and magnesium ions.

The metal lignosulfate salt of the invention is used in an amount effective to provide adsorption of the metal lignosulfate salt on the surfaces of the pesticide particles to impart a negative charge to the particle. The resulting electrostatic repulsions between particles then prevent heavy flocculation and aggregation. The effective amount of the metal lignosulfate salts is generally from about 0.5% to about 25%, preferably from about 2 to about 10%.

Examples of useful metal lignosulfate salts include those in Table 1.

TABLE 1

| | Chemical | |
|---|---|---|
| | Abstracts | |
| Chemical Characterization | Number | Trade Name |
| Mono-calcium salt of polymerized aryl | 8061-52-7 | |
| alkylsulfonic acids or Lignosulfonic acid, | | |
| calcium salt | | |
| Naphthalene sulfonic acid formaldehyde | 83453-42-3 | Krafsperse, |
| condensate, ammonium and sodium salt | | polyfon, Reax, |
| | | mixtures |
| Sulfonated Alkyl Naphthalene | 9084-06-4 | Supragil |
| Condensates, Naphthalenesulfonic Acid- | | MNS/90, |
| Formaldehyde, Sodium Salt, NaNS-F, | | Supragil |
| Naphthalene Sulfonate calcium salt | | WP, Morwet |
| | | D425 |
| Sulfonated kraft lignin and naphthalene | | Krafsperse |
| sulfonate mixture | | |
| Sodium salt of kraft lignin polymer/ | 8061-51-6 | Polyfon |
| Modified sulfite lignin | | |
| Sodium salt of sulfonated modified kraft | 105859-97-0 | Reax series |
| lignin | | |
| Lignin, alkali, reaction product with | 105859-97-0 | |
| disodium sulfite and formaldehyde | | |
| Lignosulfonic acid, sodium salt, | 68512-34-5 | |
| sulfomethylated | | |
| Ethoxylated sodium salt of sulfonated | 68611-14-3 | |
| kraft lignin | | |
| Lignin, alkali, reaction product with | 68512-35-6 | |
| sodium bisulfite and formaldehyde | | |
| Kraft Lignin | 8068-05-1 | |
| Ammonium lignosulfonate etc. | 8061-53-8 | |
| Lignin, alkali, oxidized, sodium salt | 68201-23-0 | |
| Ligninderivat | 105859-97-0 | |
| Lignosulfonic acid | 8062-15-5 | |
| Lignosulfonic acid, magnesium salt | 8061-54-9 | |
| Lignosulfonic acid, potassium salt | 37314-65-1 | |
| Lignin Solids | 9005-53-2 | |

The salts in this invention generally are water soluble alkali metal, alkaline earth metal or ammonium salts of a strong acid. Salts include lithium chloride, sodium chloride, potassium chloride, ammonium chloride, magnesium chloride, calcium chloride, lithium nitrate, sodium nitrate, potassium nitrate, magnesium nitrate, calcium nitrate, lithium sulfate, sodium sulfate, potassium sulfate, ammonium sulfate, magnesium sulfate, sodium monhydrogen phosphate, potassium monhydrogen phosphate, ammonium monohydrogen phosphate, sodium dihydrogen phosphate, potassium dihydrogen phosphate, and ammonium dihydrogen phosphate. The composition includes mixtures of two or more salts.

Generally the salt and the lignosulfate salt are admixed to provide an optimum mixture. Generally the metal lignosulfate salt and the water soluble salt are present in a ratio of from about 2:1 to about 1:20, preferably from 1:1 to 1:10.

Generally the insecticide and metal lignosulfate salt are present at a ratio of from about 60:1 to about 1: 10, preferably from about 20:1 to about 1:5, most preferably from about 20:1 to 1:1.

The fluid composition of the invention may further comprise one or more of the following features:

(e) a diluent;

(f) a surfactant; or

(g) a lubricant.

In a preferred embodiment, the fluid composition of the present invention is substantially free of a surfactant.

However, the composition can also employ lignin sulfonates with water soluble anionic and nonionic surfactants described below. Moreover, it is also possible for mixing the water soluble synthetic polymers of the alkali metal salts of homo- and co-polyacrylates with acrylic and methacrylates and the alkali metal salts of polystyrene sulfonate with other organic sulfonates and water soluble anionic and nonionic surfactants. Furthermore, mixtures of organic sulfonates and other water soluble nonionic surfactants are also possible.

The organic sulfonates in particular include ammonium, sodium, and calcium salts of alkyl naphthalene sulfonate; and ammonium and sodium salts of naphthalene formaldehyde sulfonate (CAS 83453-42-3); sodium bis (1-methylethyl)naphthalene sulfonate (CAS 1322-93-6); sodium naphthalene formaldehyde sulfonate (CAS 9084-06-4); sodium 2-naphthalene formaldehyde sulfonate (CAS 29321-75-3); sodium isethionate; sodium taurates; petroleum sulfonates, paraffin sulfonates, α-olefin sufonates and sulfosuccinates, sulfated alchohols and sulfated polyoxyethylenated alcohols, sulfated castor oil and other sulfated triglyceride oils, and sodium alkylbenzene sulfonates (benzene, toluene, xylene, and cumene sulfontes) (M. J. Rosen, Book, 198x) and sodium salt of the straight chain alkylbenzenesulfonates:(expressed in LAS/CAS code/Salt): (C₁₀₋₁₃)Alkyl-CAS 68411-30-3 (sodium salt); (C₁₀₋₁₆)Alkyl-CAS 68584-22-5, CAS 68584-23-6 (calcium salt) CAS 68584-26-9 (magnesium salt) CAS 68584-27-0 (potassium salt); Mono (C₆₋₁₂)alkyl-CAS 68608-87-7 (sodium salt); Mono(C₇₋₁₇)alkyl-CAS 68953-91-3 (calcium salt) CAS 68953-94-6 (potassium salt); Mono(C₉₋₁₂)alkyl-CAS 68953-95-7 (sodium salt); Mono(C₁₀₋₁₆)alkyl-CAS 68910-31-6 (ammonium salt) CAS 68081-81-2 (sodium salt); Mono(C₁₂₋₁₈)alkyl-CAS 68648-97-5 (potassium salt).

Surfactants can be of the emulsifying or wetting type, ionic or non-ionic. Possible surfactants include alkali metal, alkaline earth metal and ammonium salts of alkylsulfonic, phenylsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. If a surfactant is used, it is preferential to use a non-ionic surfactant. However, the non-ionic surfactant is used in an effective amount to improve the composition but in an amount to minimize foaming of the composition upon physical mixing or dilution into water. Generally the amount of any non-ionic surfactant is from 0.1 to 1% of the composition, preferably from 0.1 to 0.5% by weight of the composition. One critical criterion is that both the anionic and the nonionic surfactant must meet the requirement that it dissolves is at least substantially miscible in the water/glycerin/metal salt mixture. Preferably the HLB of the non-ionic surfactant is from about 10 to about 20.

A general description of surfactants that might be used in the present invention include nonionic surfactants such as alcohol alkoxylates C8 to 18, both linear and branched chain ethoxylates with 2 to 22 EO units and with an HLB range from 4 to 16; alkyl phenol ethoxylates, mono and di-nonyl and octyl phenol with 2 to 150 EO units, HLB range from 4 to 19; fatty amine alkoxylates, e.g., tallow, oleyl, stearyl and cocoamine alkoxylates with 2 to 50 EO units and HLB range from 4 to 18; alkanolamides; triglyceride alkoxylates, such as castor, rapeseed, soybean and colza oil ethoxylates with 5 to 54 EO units and HLB range from 4 to 15; sorbitan ester ethoxylates with 20 to 30 EO units, HLB range from 15 to 16; ethylene oxide/propylene oxide copolymers including alkoxylated rapeseed oil with ethylene oxide and propylene oxide chains; and with an HLB range from 1 to 18; alkyl polyglycosides; fatty acid ethoxylates; fatty acid polyethylene glycols; fatty alcohol ethoxylates; di- and tri-styrylphenol ethoxylates; glycerol esters; Star® polymers; and polyol ethoxylate esters.

Anionic Surfactants that may be used in the present invention include sulfates, fatty alcohol ether sulfates, fatty acid sulfates; sulfonates, alkylbenzenesulfonates, alkyl naphthalene sulfonates, alkylaryl sulfonates, olefin sulfonates, alkylphenol ethoxylate sulfates; phosphates, such as phosphates of fatty alcohol ethoxylate, phosphates of alkylphenol ethoxylate having 4 to 12 EO units; alkyl sulfosuccinates; carboxylates, alkylphenol ethoxylate carboxylates.

By the term diluent is meant a liquid which decreases the concentration of the compound of formula (I) in the fluid. Preferred diluents also are added in sufficient amounts to increase the viscosity of the fluid and provide a resulting fluid with thixotropic properties. The diluent may also function as an antifreeze. Examples of preferred diluents include the polyhydroxylated alkanes, e.g., ethylene glycol, propylene glycol (otherwise known as glycerine, or 1,2,3-propanetriol), tetramethylene glyol, pentamethylene glycol, triethylene glycol, diethylene glycol, glycerin, hexamethylene glycol and a polyethylene glycol. Generally, diluents have a density of from 1 to 4 g/mL at standard temperature and standard pressure (25° C. and 760 mm Hg respectively) and a viscosity of from 2000 to 4000 cp (centipoise) as measured by an rotating plate Ostwald viscosimeter at standard temperature and pressure.

Lubricants used in the present invention which enhance mechanical shearing of the composition include silica prepared by precipitating water glass (sodium silicate) with sulfuric acid, which is then dried and sold as a fine powder. The silica powder functions as a viscosity builder yet providing rheology control and aid in suspension by preventing a settling effect. Use of such a lubricant to form an effective thixotrope allows the formulation particles to self assemble into a mechanically shearable composition.

Another lubricant is fumed alumina. Fumed alumina is produced by the hydrolysis of aluminum trichloride in a hydrogen-oxygen flame. The combustions process creates aluminum oxide molecules which condense to form primary particles which sinter together to form aggregates. These aggregates have a chain-like structure and an average diameter of 0.1 and 0.2 microns.

Fumed alumina in this invention, like the precipitated silica, has small particle size in the submicron range (for primary particle size of 20 nm and aggregate size of 150 nm) down to nanometer particle size with B.E.T. surface area of 55 m²/g. It also provides rheology control and lubrication for the suspension concentrate.

Clays may also be optionally used in the present composition. Such clays include kaolinite, dickite, and nacrite, with the general formula of Al₂Si₂O₅(OH)₄; pyrophylite, talc, vermiculite, sauconite, saponte, nontronite, and montmoriflonite with the general chemical formula (Ca, Na, H) (Al, Mg, Fe, Zn)₂ (Si, Al)₄O₁₀(OH)₂.xH₂O; attapulgite with the general chemical formula MgSi₈O₂₀(HO)₂(OH₂)₄.₄H₂O; and illite with the general formula (K, H) A12(Si, A)₄O₁₀(OH)₂.xH₂O.

Fertilizers that are compatible with the composition of the present invention are generally liquid fertilizer compositions for any available use. Such fertilizers are generally measured by a nitrogen-phosphorous-potassium index providing the amounts of each ingredient as a weight-weight percentage of each major component. Nitrogen content is generally from 1 to 40%; phosphorous content is from 0 to 55% and potassium content is from 0 to 15%. Generally the liquid fertilizers are formulated as an aqueous composition. Such fertilizers are known to those of ordinary skill in the art.

The composition of the invention is also substantially compatible with micronutrient compositions which contain such elements as boron, cobalt, copper, iron, magnesium, molybdenum, potassium, sodium, sulfur and zinc ions.

The compound of formula (I) has preferred embodiments.

If R is acyl, preferred embodiments are formyl, alkylcarbonyl, and arylcarbonyl, or R may be alkylsulfonyl, arylsulfonyl, (alkyl)-(aryl)-phosphoryl, which may in turn be substituted.

The term acyl comprises the following definitions. By the term “C₂-C₆ alkanoyl” is meant straight or branched chain alkanoyl groups having from 2 to 6 carbon atoms. Examples of C₂-C₆ alkanoyl are acetyl, propanoyl, butanoyl, pentanoyl, hexanoyl, lauroyl, myristoyl, palmitoyl, stearoyl, eicosanoyl, lignoceroyl and isomeric forms thereof.

The term “C₇-C₁₁ aroyl” refers to benzoyl and 1- or 2-naphthoyl.

The term “C₇-C₁₆ aralkanoyl” refers to C₁-C₆ alkanoyl substituted with C₆-C₁₀ aryl such that the total number of carbon atoms is from 7 to 16. An example of C₇-C₁₁ aralkanoyl is phenacetyl.

The term “(C₁-C₆ alkoxy)carbonyl” refers to straight or branched chain alkoxycarbonyl groups having from 1 to 6 carbon atoms in the alkoxy portion. Examples of (C₁-C₆ alkoxy)carbonyl are methoxycarbonyl, ethoxycarbonyl, propoxycarbonyl, butoxycarbonyl, pentyloxycarbonyl, hexyloxycarbonyl, and the isomeric forms thereof.

The term “(C₆-C₁₀ aryloxy)carbonyl” refers to phenoxycarbonyl and 1- or 2-naphthoxycarbonyl, in which the aryl portion can optionally be further substituted with halogen, alkyl, alkoxy, alkoxycarbonyl, or nitro.

The term “carbamoyl” refers to an unsubstituted aminocarbonyl group.

The term “(C₁-C₆ alkylamino)carbonyl” refers to straight or branched chain alkylamino-substituted carbonyl groups having from 1 to 6 carbon atoms in the alkylamino portion. Examples of (C₁-C₆ alkanoyl)amino are methylaminocarbonyl (also known as N-methylcarbamoyl), ethylaminocarbonyl, and the like. Such alkylaminocarbonyl groups can optionally be N-substituted with alkyl or aryl groups.

The term “(C₆-C₁₀ arylamino)carbonyl” refers to phenylaminocarbonyl (or anilinocarbonyl) and 1- or 2-naphthylaminocarbonyl. Such arylaminocarbonyl groups can optionally be N-substituted with alkyl or aryl groups.

The term “(C₇-C₁₆ aralkoxy)carbonyl” refers to (C₁-C₆ alkoxy)carbonyl substituted with C₆-C₁₀ aryl such that the total number of carbon atoms in the aralkoxy portion is from 7 to 16. An example of (C₇-C₁₆ aralkoxy)carbonyl is benzyloxycarbonyl (also known as carbobenzoxy).

The term “C₁-C₆ alkylsulfonyl” refers to straight or branched chain alkylsulfonyl groups having from 1 to 6 carbon atoms. Examples of C₁-C₆ alkylsulfonyl are methylsulfonyl (also known as mesyl) and ethanesulfonyl.

The term “C₁-C₆ alkylsulfinyl” refers to straight or branched chain alkylsulfinyl groups having from 1 to 6 carbon atoms. Examples of C₁-C₆ alkylsulfinyl are methylsulfinyl and ethanesulfinyl.

The term “C₆-C₁₀ arylsulfonyl” refers to phenylsulfonyl and 1- or 2-naphthylsulfonyl, as well as optionally substituted forms such as toluenesulfonyl (also known as tosyl).

The term “C₆-C₁₀ arylsulfinyl” refers to phenylsulfinyl and 1- or 2-naphthylsulfonyl, as well as optionally substituted forms such as toluenesulfinyl (also known as tosyl).

If R is alkyl, preferred embodiments are C₁₋₁₀-alkyl, especially C₁₋₄-alkyl, specifically methyl, ethyl, i-propyl, sec- or t-butyl, which may in turn be substituted by one more halogen atoms. By the term halogen is meant F, Cl, Br and I.

If R is aryl, phenyl and naphthyl, especially phenyl are preferred. As used herein, the term “aryl” also refers to phenyl and naphthyl groups substituted with alkyl, alkoxy, halogen, hydroxy (including tautomeric oxo forms), alkoxycarbonyl, aryloxycarbonyl, cyano, and nitro as defined herein.

If R is aralkyl, preferred embodiments are phenylmethyl and phenylethyl. By the term “C₇-C₁₆ aralkyl” is meant C₁-C₆ alkyl substituted with C₆-C₁₀ aryl such that the total number of carbon atoms is from 7 to 16. Examples of C₇-C₁₆ aralkyl are benzyl, phenethyl, and naphthylmethyl.

R may be heteroaryl. By the term heteroaryl is meant a heterocycle having up to 10 ring atoms and N, O, S especially N as heteroatoms wherein the ring is unsaturated to provide an electronically aromatic system following Hückel's Rule. Heteroaryl may be a five-or six-membered aromatic groups having one or more ring heteroatoms, such as nitrogen, oxygen, and sulfur, and fused-ring analogs thereof. Heteroaryl may be substituted with hydroxy (including tautomeric oxo forms), halogen, alkyl, alkoxy, alkoxycarbonyl, or aryloxycarbonyl. Suitable heteroaryl groups include pyridyl, pyrimidyl, imidazolyl, and thiazolyl, Especially preferred embodiments include thienyl, furyl, thiazolyl, imidazolyl, pyridyl and benzothiazolyl rings. Heteroaryl may be further substituted with hydroxy (including tautomeric oxo forms), halogen, alkyl, alkoxy, alkoxycarbonyl, or aryloxycarbonyl. Suitable heteroaryl groups include pyridyl, pyrimidyl, imidazolyl, and thiazolyl,

R may be heteroarylalkyl. By the term heteroarylalkyl is meant a heteroaryl moiety attached to an alkyl radical. Examples include heterooarylmethyl and heteroarylethyl with the heteroaryl moiety having up to 6 ring atoms and N, O, S, especially N as heteroatoms.

Substituents which may be listed by way of example and preference are alkyl having preferably 1 to 4, in particular 1 or 2 carbon atoms, such as methyl, ethyl, n- and i-propyl and n-, i- and t-butyl; alkoxy having preferably 1 to 4, in particular 1 or 2 carbon atoms, such as methoxy, ethoxy, n- and i-propyloxy and n-, i- and t-butyloxy; alkylthio having preferably 1 to 4, in particular 1 or 2 carbon atoms, such as methylthio, ethylthio, n- and i-propylthio and n-, i- and t-butylthio; halogenoalkyl having preferably 1 to 4, in particular 1 or 2 carbon atoms and preferably 1 to 5, in particular 1 to 3 halogen atoms, the halogen atoms being identical or different and being preferably fluorine, chlorine or bromine, especially fluorine, such as trifluoromethyl; hydroxyl; halogen, preferably fluorine, chlorine, bromine and iodine, especially fluorine, chlorine and bromine; cyano; nitro; amino; monoalkyl- and dialkylamino having preferably 1 to 4, in particular 1 or 2 carbon atoms per alkyl group, such as methylamino, methyl-ethyl-amino, n- and i-propylamino and methyl-n-butylamino; carboxyl; carbalkoxy having preferably 2 to 4, in particular 2 or 3 carbon atoms, such as carbomethoxy and carboethoxy; sulfo (—SO₃H); alkylsulfonyl having preferably 1 to 4, in particular 1 or 2 carbon atoms, such as methylsulfonyl and ethylsulfonyl; arylsulfonyl having preferably 6 or 10 aryl carbon atoms, such as phenylsulfonyl, and also heteroarylamino and heteroarylalkylamino such as chloropyridylamino and chloropyridylmethylamino.

A preferably is hydrogen and optionally substituted radicals from the series acyl, alkyl, aryl, which preferably have the meanings given for R. A additionally represents a bifunctional group. There may be mentioned optionally substituted alkylene group having from 1 to 4 carbon atoms in particular from 1 to 2 carbon atoms. Substituents on the alkylene chain include those listed under the definition of R. The alkylene groups may be interrupted by heteroatoms N, O, or S.

Alternatively, A and Z may, together with the atoms to which they are attached, form a saturated or unsaturated heterocyclic ring. The heterocyclic ring can contain a further 1 or 2 identical or different heteroatoms and/or hetero-groups. Heteroatoms are preferably oxygen, sulfur or nitrogen, and hetero-groups are preferably N-alkyl, where the alkyl in the N-alkyl group preferably contains 1 to 4, in particular 1 or 2 carbon atoms. The alkyl group is preferably methyl, ethyl, n- and i-propyl and n-, i- or t-butyl. The heterocyclic ring contains 5 to 7, preferably 5 or 6 ring members.

When A and Z together with the atoms to which they are attached will preferably form a heterocycle which includes imidazolidine, pyrrolidine, piperidine, piperazine, hexamethyleneimine, hexahydro-1,3,5-triazine, hexahydrooxodiazine, morpholine, each of which may optionally be substituted by lower alkyl, preferably by methyl.

X preferably represents —CH═ or —N═.

Z represents the optionally substituted radicals alkyl, —OR″, —SR″, —NR″R″, where R″ and the substituents preferably have the meaning given above for the substituents of R.

When X is ═CR′, Z can form with X a saturated or unsaturated heterocyclic ring. The heterocyclic ring can contain a further 1 or 2 identical or different heteroatoms and/or hetero-groups. The heteroatoms are preferably oxygen, sulfur or nitrogen, and the hetero-groups N-alkyl, in which case the alkyl or N-alkyl group preferably contains 1 to 4, in particular 1 or 2 carbon atoms. As alkyl there may be mentioned methyl, ethyl, n- and i-propyl and n-, i- and t-butyl. The heterocyclic ring contains 5 to 7, preferably 5 or 6 ring members. Examples of the heterocyclic ring which may be mentioned are pyrrolidine, piperidine, piperazine, hexamethyleneimine, morpholine and N-methylpiperazine.

As compounds which may be used with very particular preference in accordance with the invention, mention may be made of compounds of the general formulae (II), (III) and (IV): 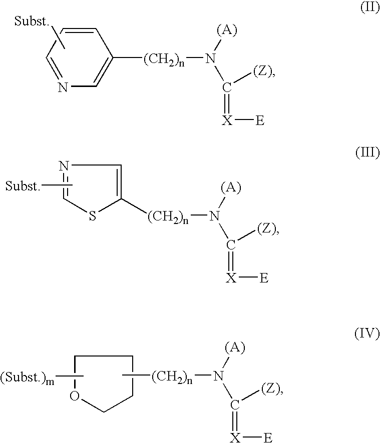
in which
n represents 1 or 2,
m represents 0, 1 or 2,

Subst. represents one of the above-listed substituents for R, especially halogen, very particularly chlorine,

Particular emphasis is given to the compounds

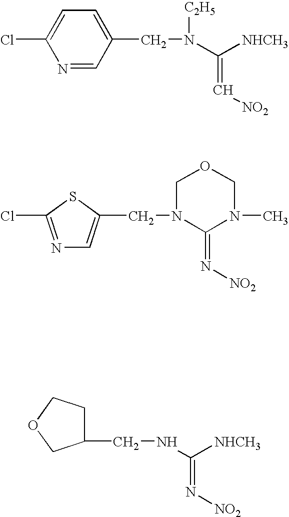

Furthermore, particular emphasis is given to the compounds

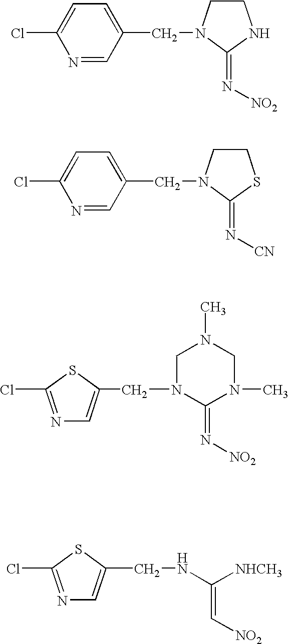

Compounds of formula (I) are known, for example, from European Offenlegungsschriften Nos. 580553, 464830, 428941, 425978, 386565, 383091, 375907, 364844, 315826, 259738, 254859, 235725, 212600, 192060, 163855, 154178, 136636, 303570, 302833, 306696, 189972, 455000, 135956, 471372, 302389; German Offenlegungsschriften Nos. 3639877, 3712307; Japanese Offenlegungsschriften Nos. 03220176, 02207083, 63307857, 63287764, 03246283, 049371, 03279359, 03255072; U.S. Pat. Nos. 5,034,524, 4,948,798, 15 4,918,086, 5,039,686, 5,034,404; PCT Applications No. WO 91/17659, 91/4965; French Application No. 2611114; Brazilian Application No. 8803621.

### EXAMPLES

### Example 1

### Liquid Phase Study

This study was done to determine that the medium viscosity is low when there is no active ingredient present. The following solutions were prepared by adding ingredients and mixing using a Ross mixer. A 10 mL sample was added to a 50 mL graduated cylinder and the cylinder was shaken vigorously 20 times. The amount of foam was measured as the per cent of the 50 mL volume. The viscosity of each sample was measured using Brookfield viscometer, LVTD, # 3 spindle and a speed of 30 rpm with a setting of F=2 for all readings. Specific Gravity measurements were taken performed using a neat sample. Measurements of pH were taken of neat samples. Freezing and thawing temperatures were determined by placing samples in a −20° C. freezer overnight and then allowing the samples to warm. A freezing temperature was recorded when the sample was completely fluid with no noticeable ice crystals present. Tables 2 and 3 show the results of the liquid phase study. There was noticeably more foaming when Agnique PG 9116 was present. Agnique PG 9116 is a C₉-C₁₁ alkyl polyglycoside non-ionic surfactant with a 1.6% average degree of polymerization available from Cognis Chemicals, website http://www.cognis.com/cognis.html.

TABLE 2
Liquid Phase Study 1

| | % wt in final | | | | | | | | | |
|---|---|---|---|---|---|---|---|---|---|---|
| | formula | 1 | 2 | 3 | 4 | 5 | 6 | 7 | 8 | 9 |
| Deionized Water | 32.0 | 96 g | 96 g | 96 g | 96 g | 96 g | 96 g | 96 g | 96 g | 96 g |
| Glycerine | 12.0 | 36 g | 36 g | 36 g | 36 g | 36 g | 36 g | 36 g | | 36 g |
| Borresperse NA | 3.5 | 10.5 g | | | 10.5 g | | 10.5 g | 10.5 g | | |
| Agnique PG 9116 | 0.5 | | 1.5 g | | 1.5 g | 1.5 g | | 1.5 g | | |
| Potassium Chloride | 4.0 | | | 12 g | | 12 g | 12 g | 12 g | | |
| Appearance | | clear dark | clear | clear | clear dark | clear | clear | clear dark | clear | |
| | | brown | colorless | colorless | brown | colorless | dark | brown | colorless | |
| | | liquid, | liquid | liquid, | liquid, | liquid | brown | liquid, | liquid, | |
| | | slight | with | no foam | with | with | liquid, | with | no foam | |
| | | foam | significant | | significant | significant | slight | significant | | |
| | | | foam | | foam | foam | foam | foam | | |
| Foaming, vol. % | | 8 | 80 | 0 | 76 | 60 | 10 | 80 | 0 | 0 |
| Viscosity, cps | | 7.0 | 4.0 | 2.8 | 3.4 | 3.6 | 4.4 | 4.2 | 2.0 | 2.4 |
| Specific Gravity | | 1.098 | 1.067 | 1.119 | 1.098 | 1.117 | 1.144 | 1.136 | 1.000 | 1.067 |
| pH | | 7.5 | 8.85 | 6.74 | 7.47 | 6.93 | 7.45 | 7.49 | 9.19 | 8.42 |
| Freeze/Thaw | | −8 C. | −6 C. | −12 C. | −9 C. | −13 C. | −13 C. | −13 C. | 0 | −6 C. |
| Temp. C. | | | | | | | | | | |

TABLE 3
Liquid Phase Study 2

| | % wt in final | | | | | | | |
|---|---|---|---|---|---|---|---|---|
| | formula | 10 | 11 | 12 | 13 | 14 | 15 | |
| Deionized Water | 32.0 | 96 g | 96 g | 96 g | 96 g | 96 g | 96 g | 96 g |
| Borresperse NA | 3.5 | 10.5 g | | | 10.5 g | | 10.5 g | 10.5 g |
| Agnique PG 9116 | 0.5 | | 1.5 g | | 1.5 g | 1.5 g | | 1.5 g |
| Potassium chloride | 4.0 | | | 12 g | | 12 g | 12 g | 12 g |
| Appearance | | clear dark | clear | clear | clear dark | clear | clear | clear drak |
| | | brown | colorless | colorless | brown | colorless | dark | brown liquid |
| | | liquid, | liquid | liquid, | liquid, | liquid | brown | with |
| | | slight | with | no foam | with | with | liquid, | significant |
| | | foam | significant | | significant | significant | slight | foam |
| | | | foam | | foam | foam | foam | |
| Foaming, Vol % | | 14 | 84 | 0 | 78 | 94 | 16 | 90 |
| Viscosity | | 4.0 | 2.6 | 2.6 | 3.6 | 2.8 | 3.0 | 4.0 |
| Specific Gravity | | 1.044 | 1.001 | 1.072 | 1.044 | 1.072 | 1.109 | 1.108 |
| pH | | 7.63 | 8.78 | | 7.63 | 7.44 | 7.42 | 7.49 |
| Freeze/Thaw Temp | | 0 C. | 0 C. | −1 C. | 0 C. | −2 C. | −4 C. | −6 C. |

### Example 2

### Suspension Phase Study

The procedures of Example 1 were performed on the compositions of Tables 4 and 5. The mixtures were prepared by mixing the ingredients first, followed by grinding the contents using a Silverson mixer. The lignin sulfonate medium is studied to show that generally the medium viscosity is low when there is no Al involved. It was observed that some formulation media foamed a lot when there is nonionic surfactant such as Agnique PG 9116 is present in the medium. Freezing and thawing points were not measured. Borresperse NA is sodium lignosulfate, CAS number 8061-51-6, supplied by Lignotech. Hi-Sil 233 is Hydrated Amorphous Silica Gel, CAS number 112926-00-8, available from PPG Industries, Inc. Attagel 50 is an attapulgite clay available from Engelhard Corporation.

### Example 2

### Suspension Phase Study

The procedures of Example 1 were performed on the compositions of Tables 4 and 5. The mixtures were prepared by mixing the ingredients first, followed by grinding the contents using a Silverson mixer. The lignin sulfonate medium is studied to show that generally the medium viscosity is low when there is no Al involved. It was observed that some formulation media foamed a lot when there is nonionic surfactant such as Agnique PG 9116 is present in the medium. Freezing and thawing points were not measured. Borresperse NA is sodium lignosulfate, CAS number 8061-51-6, supplied by Lignotech. Hi-Sil 233 is Hydrated Amorphous Silica Gel, CAS number 112926-00-8, available from PPG Industries, Inc. Attagel 50 is an attapulgite clay available from Engelhard Corporation.

TABLE 4
Supension Study 1

| | 17 | 18 | 19 | 20 | 21 | 22 | 23 | 24 | 25 | 26 | 27 |
|---|---|---|---|---|---|---|---|---|---|---|---|
| Deionized Water | 96 g | 96 g | 96 g | 96 g | 96 g | 96 g | 96 g | 96 g | 96 g | 96 g | 96 g |
| Glycerine | 36 g | 36 g | 36 g | 36 g | 36 g | 36 g | 36 g | 36 g | 36 g | 36 g | 36 g |
| Borresperse NA | 10.5 g | 10.5 g | 10.5 g | 10.5 g | 10.5 g | 10.5 g | 10.5 g | 10.5 g | 10.5 g | 10.5 g | 10.5 g |
| Potassuim chloride | | | | | | 12 g | 12 g | 12 g | 12 g | 12 g | 12 g |
| Aluminum Oxide C | 1.2 g | | | 1.2 g | 1.2 g | | | | 1.2 g | 1.2 g | 1.2 g |
| Hi-Sil 233 | | 0.3 g | | 0.3 g | 0.3 g | 0.3 g | | 0.3 g | | 0.3 g | 0.3 g |
| Attagel 50 | | | 0.3 g | | 0.3 g | | 0.3 g | 0.3 g | | | 0.3 g |
| Appearance | hazy | clear | clear | hazy | hazy | clear | clear | clear | hazy | hazy | hazy |
| | brown | brown | brown | brown | brown | brown | brown | brown | brown | brown | brown |
| | liquid | liquid | liquid | liquid | liquid | liquid | liquid | liquid | liquid | liquid | liquid |
| | with | with | with | with | with | with | with | with | with | with | with |
| | slight | slight | slight | slight | slight | slight | slight | slight | slight | slight | slight |
| | foam | foam | foam | foam | foam | foam | foam | foam | foam | foam | foam |
| Foaming vol. % | 8 | 8 | 8 | 8 | 10 | 8 | 8 | 10 | 12 | 8 | 8 |
| Viscosity, cps | 5.8 | 7.8 | 9 | 4.2 | 5.2 | 5.6 | 5.6 | 3.6 | 5.8 | 4.8 | 4.4 |
| Specific Gravity | 1.105 | 1.095 | 1.099 | 1.104 | 1.106 | 1.140 | 1.145 | 1.140 | 1.148 | 1.149 | 1.148 |
| pH | 7.61 | 7.63 | 7.66 | 7.59 | 7.65 | 7.34 | 7.45 | 7.4 | 7.35 | 7.32 | 7.4 |

TABLE 5
Supension Study 2

| | 28 | 29 | 30 | 31 | 32 | 33 | 34 | 35 | 36 | 37 | 38 |
|---|---|---|---|---|---|---|---|---|---|---|---|
| Deionized Water | 96 g | 96 g | 96 g | 96 g | 96 g | 96 g | 96 g | 96 g | 96 g | 96 g | 96 g |
| Borresperse NA | 10.5 g | 10.5 g | 10.5 g | 10.5 g | 10.5 g | 10.5 g | 10.5 g | 10.5 g | 10.5 g | 10.5 g | 10.5 g |
| Potassium chloride | | | | | | 12 g | 12 g | 12 g | 12 g | 12 g | 12 g |
| Aluminum Oxide C | 1.2 g | | | 1.2 g | 1.2 g | | | | 1.2 g | 1.2 g | 1.2 g |
| Hi-Sil 233 | | 0.3 g | | 0.3 g | 0.3 g | 0.3 g | | 0.3 g | | 0.3 g | 0.3 g |
| Attagel 50 | | | 0.3 g | | 0.3 g | | 0.3 g | 0.3 g | | | 0.3 g |
| Appearance | hazy | clear | clear | Hazy | hazy | clear | clear | clear | hazy | hazy | hazy |
| | brown | brown | brown | brown | brown | brown | brown | brown | brown | brown | brown |
| | liquid | liquid | liquid | liquid | liquid | liquid | liquid | liquid | liquid | liquid | liquid |
| | with | with | with | with | with | with | with | with | with | with | with |
| | slight | slight | slight | slight | slight | slight | slight | slight | slight | slight | slight |
| | foam | foam | foam | foam | foam | foam | foam | foam | foam | foam | foam |
| Foaming, vol. % | 14 | 14 | 14 | 18 | 16 | 16 | 16 | 16 | 16 | 16 | 16 |
| Viscosity, cps | 2.4 | 2 | 2.4 | 2.6 | 2.4 | 2.2 | 2 | 2.8 | 3 | 2.6 | 3.2 |
| Specific Gravity | 1.051 | 1.045 | 1.045 | 1.04 | 1.054 | 1.102 | 1.109 | 1.109 | 1.114 | 1.115 | 1.117 |
| pH | 7.54 | 7.44 | 7.63 | 7.55 | 7.57 | 7.26 | 7.37 | 7.34 | 7.34 | 7.25 | 7.3 |

### Example 3

Examples 39 through 42 were prepared from a wet-milled master batch of 328 g Imidacloprid, 32 g, Borresperse NA, and 540 g water. The milling was carried out in a lab Dynomil milling device. After the particle size had reached 2.6 micron (<50% volume average), the resultant mill base was collected and subdivided. To each sample salt and/or glycerin was added to finish the formulations (Examples 39 to 42). The formulations demonstrated surprising compatibility with fertilizers tested (Table 6, 10-34-0, 3-18-18, and 6-24-6). A reference formula (Example 43, Table 6) using the traditional surfactants alone was prepared for comparison. The fertilizer compatibility test in this invention is carried out to simulate the field test conditions (0.22 lb active ingredient per 5 gallons fertilizer); and the corresponding laboratory rate is 0.375 g active ingredient per 100 g fertilizer. Then the whole mixture is filtered through a screen of US Mesh 50, the net retained residues are measured and reported. The results demonstrated the superior compatibility of the Borresperse NA plus salt as a synergistic dispersant system to that of using common surfactants. Morwet D425 is the sodium salt of alkylnaphthalenesulfonate formaldehyde polymer CAS # 9084-06-4, alternatively identified with CAS numbers 68425-94-5, 83453-42-3, and 9008-63-3. Alkamuls EL 620 is a fatty acid ethoxylate non-ionic surfactant from Rhodia, Inc.

Examples of 44 to 49 (Table 7) were prepared like those in Tables 4, 5 and 6. All ingredients including Imidacloprid were mixed well before wet milling. The mixture was milled to an average partilcle size of 2.8 microns before discharge. Formulation specific gravity, viscosities were measured before testing for fertilizer compatibilities. It is surprising that the combined Ingredients of Aluminum Oxide, Attagel 50, and Hi Sil 233 further improved the integrity of the resultant formulations. Furthermore, fertilizer tests of these examples showed the significance of glycerin stabilizing the fertilizer dilutions. Lastly the controlled flocculation phenomena with shear thinning effect are clearly shown due to the presence of salt (e.g., potassium chloride).

TABLE 6

| | 39 | 40 | 41 | 42 | 43 |
|---|---|---|---|---|---|
| Imidacloprid | 31 | 31 | 31 | 31 | 31 |
| Morwet D425 | | | | | 2 |
| Alkamuls EL 620 | | | | | 1 |
| Borresperse NA | 3 | 3 | 3 | 3 | |
| KCl | | 2 | 2 | | |
| Zn Sulfate | 0.2 | | | 0.2 | |
| Glycerine | | | 13 | 14.8 | |
| Water | 65.8 | 64 | 51 | 51 | 66 |
| Total (% weight) | 100 | 100 | 100 | 100 | 100 |
| Specific Gravity, | 1.133 | 1.145 | 1.191 | 1.177 | 1.127 |
| g/ml | | | | | |
| Viscosity, cps, set | 83 | 56 | 64 | 54 | |
| Viscosity, cps, | 15 | 8 | 14 | 20 | 9.6 |
| stirred | | | | | |
| 10-34-0 Fertilizer + 50 | 0 | 0 | 0 | 0 | 0 |
| Mesh Net | | | | | |
| Retain, %* | | | | | |
| 3-18-18 Fertilizer + 50 | 0.09 | 0.17 | 0.06 | 0.06 | 0.18 |
| Mesh Net | | | | | |
| Retain, %* | | | | | |
| 6-24-6 Fertilizer + 50 | 0.01 | 0.09 | 0.1 | 0.04 | 0.13 |
| Mesh Net | | | | | |
| Retain, %* | | | | | |

TABLE 7
Basic Formulation Study

| | 44 | 45 | 46 | 47 | 48 | 49 |
|---|---|---|---|---|---|---|
| Imidacloprid | 47.1 g | 47.1 g | 47.1 g | 47.1 g | 47.1 g | 47.1 g |
| Borresperse NA | 3.50 g | 3.50 g | 3.50 g | 3.50 g | 3.50 g | 3.50 g |
| Agnique PG 9116 | 0.50 g | 0.50 g | 0.50 g | 0.50 g | 0.50 g | 0.50 g |
| Glycerine | 12.00 g | 12.00 g | 12.00 g | | | |
| Aluminum Oxide C | 0.40 g | 0.40 g | | 0.40 g | 0.40 g | |
| Attagel 50 | 0.10 g | 0.10 g | 0.20 g | 0.10 g | 0.10 g | 0.20 g |
| Potassuim Chloride | 4.00 g | | 4.00 g | 4.00 g | | 4.00 g |
| Hi-Sil 233 | 0.10 g | 0.10 g | 0.20 g | 0.10 g | 0.10 g | 0.20 g |
| Water | 32.00 g | 32.00 g | 32.00 g | 44.00 g | 44.00 g | 44.00 g |

Results

| | | | | | | |
|---|---|---|---|---|---|---|
| Formulation | 1.302 | 1.276 | 1.294 | 1.259 | 1.231 | 1.257 |
| Specific Gravity, g/ml | | | | | | |
| Formulation Viscosity, cps | >4000 | 492 | >4000 | 2400 | 480 | >4000 |
| (set) | | | | | | |
| Formulation Viscosity, cps | 480 | 180 | 956 | 276 | 84 | 352 |
| (stirred) | | | | | | |
| Dilution in 342 ppm water* | <0.1 ml | <0.1 ml | <0.1 ml | 0.1 ml | 0.1 ml | 0.1 ml |
| | sediment, Good | sediment, Good | sediment, Good | sediment, | sediment, | sediment, |
| | resuspension | resuspension | resuspension | Some residue | Some residue | Some residue |
| | after 24 hours | after 24 hours | after 24 hours | on | on | on |
| | | | | resuspension | resuspension | resuspension |
| Dilution in 10-34-0 Fertilzer | Good dispersion, | Good | Good | good | good | good |
| after pre-dilution with water** | Good | dispersion, | dispersion, | dispersion, | dispersion, | dispersion, |
| | resuspension. | Good | Good | Some sticky | Some sticky | Some sticky |
| | | resuspension | resuspension | residues with | residues with | residues with |
| | | | | resuspension | resuspension | resuspension |

*Water dilution test: 0.31 ml/95 g 342 ppm H2O
**1:2 dilution with H2O at 0.95 ml/99 g 10-34-0 Fertilizer.

### Example 4

Two reference formulations (Table 8, Examples 50 and 51) with 25 weight % Imidacloprid in 300 g batch were prepared in traditional suspension concentrate technology using standard wet-milling technique. All ingredients except Kelzan (Xanthan Gum) were charged to a container beforehand and pre-ground using a rotary Silverson mixer followed by wet milling. The milling was carried out in a lab Dynomil apparatus until the particle size reached 2.5 micron (<50% volume average). To finish the formulation, Kelzan was post added to the discharged mill bases.

Examples 52 to 54 (Table 9) are formulations containing 25 weight % insecticide with various salts; Examples 55 to 58 (Table 10) are formulations with various Lignin Sulfonate dispersant combinations. Shear thinning effect is prominent throughout the examples. Examples 59 to 62 (Table 11) are formulations containing nonionic surfactant in addition to the Lignin Sulfonate. Relatively speaking, the shear thinning in this systems is minimized, clearly due to the effect of the nonionic surfactants.

TABLE 8

| | 50 | 51 |
|---|---|---|
| Imidacloprid | 25.0 | 25.0 |
| Morwet D425 | 2.0 | |
| Geropon T 36 | | 2.25 |
| Alkamul EL620 | 1.0 | |
| APG 9116 | | 0.5 |
| Vangel B | 0.5 | 0.3 |
| Hi Sil 233 | | 0.2 |
| Kelzan | 0.5 | 0.5 |
| Water | 71.0 | 71.25 |
| Total | 100 | 100 |
| Specific Gravity, g/ml | 1.065 | 1.004 |
| Viscosity*, cps (set) | 2544 | 3208 |
| Viscosity*, cps (stirred) | 2496 | 3104 |

TABLE 9

| | 52 | 53 | 54 |
|---|---|---|---|
| Imidacloprid | 25.00 | 25.00 | 25.00 |
| Borresperse NA | 2.50 | 2.50 | 2.50 |
| Glycerin | 8.00 | 8.00 | 8.00 |
| Aluminum Oxide C | 0.30 | 0.30 | 0.30 |
| Attagel 50 | 2.50 | 2.50 | 2.50 |
| Hi-Sil 233 | 1.50 | 1.50 | 1.50 |
| Sodium Sulfate | 3 | | |
| Calcium Chloride | | 0.5 | |
| Zinc Sulfate | | | 0.5 |
| Water | 57.2 | 59.7 | 59.7 |
| Total | 100 | 100 | 100 |
| Specific Gravity, | 1.159 | 1.186 | 1.168 |
| g/ml | | | |
| Viscosity, cps, set | 2280 | 2300 | 1040 |
| Viscosity, cps, stirred | 1160 | 1648 | 864 |

TABLE 10

| | 55 | 56 | 57 | 58 |
|---|---|---|---|---|
| Imidacloprid | 25.00 | 25.00 | 25.00 | 25.00 |
| Borresperse NA | 1.50 | 1.50 | 1.50 | 1.50 |
| Glycerin | 8.00 | 8.00 | 8.00 | 8.00 |
| Aluminum Oxide C | 0.30 | 0.30 | 0.30 | 0.30 |
| Attagel 50 | 2.50 | 2.50 | 2.50 | 2.50 |
| Hi-Sil 233 | 1.50 | 1.50 | 1.50 | 1.50 |
| Potassium chloride | 3 | 3 | 3 | 3 |
| Ultrazine CA | 1 | | | |
| Supragil WP | | 1 | | |
| Geropon SDS | | | 1 | |
| Lignosperse AGK 200 | | | | 1 |
| Water | 57.2 | 57.2 | 57.2 | 57.2 |
| Total | 100 | 100 | 100 | 100 |
| Specific Gravity, g/ml | 1.183 | 1.18 | 1.185 | 1.183 |
| Viscosity, cps, set | 4040 | 10160 | 4120 | 3320 |
| Viscosity, cps, stirred | 3064 | 8560 | 3332 | 1044 |

TABLE 11

| | 59 | 60 | 61 | 62 |
|---|---|---|---|---|
| Imidacloprid | 25.00 | 25.00 | 25.00 | 25.00 |
| Borresperse NA | 1.50 | 1.50 | 1.50 | 1.50 |
| Glycerin | 8.00 | 8.00 | 8.00 | 8.00 |
| Aluminum Oxide C | 0.30 | 0.30 | 0.30 | 0.30 |
| Attagel 50 | 2.50 | 2.50 | 2.50 | 2.50 |
| Hi-Sil 233 | 1.50 | 1.50 | 1.50 | 1.50 |
| Potassium chloride | 3 | 3 | 3 | 3 |
| Pluronic P 65 | 1 | | | |
| Iconol DA-6 | | 1 | | |
| Soprophor 796P | | | 1 | |
| Alkamul EL-620 | | | | 1 |
| Water | 57.2 | 57.2 | 57.2 | 57.2 |
| Total | 100 | 100 | 100 | 100 |
| Specific Gravity, g/ml | 1.176 | 1.176 | 1.184 | 1.18 |
| Viscosity, cps, set | 8460 | 3320 | 1920 | 1780 |
| Viscosity, cps, stirred | 13200 | 2744 | 1624 | 1432 |

### Example 5

The Samples 50-62 were tested for fertilizer compatibility. Three fertilizers known for their harsh compatibility with many pesticides used in the filed were selected for testing purposes. They are (N—P—K) 10-34-0, 3-18-18 and 6-24-6. The same tank mixing method as in Table 6 was used and the results are compared in Table 12. It is clear that the new technology from this invention is superior to the traditional suspension concentrate in the area of fertilizer compatibility. A commercial pesticide formulation, Admire 2F, is included in the test. It is known that Admire 2F is made with old suspension concentrate technology.

TABLE 12

| | Example | | | | | | | | | | | | | |
|---|---|---|---|---|---|---|---|---|---|---|---|---|---|---|
| | | | Admire | | | | | | | | | | | |
| | 50 | 51 | 2F | 52 | 53 | 54 | 55 | 56 | 57 | 58 | 59 | 60 | 61 | 62 |
| 10-34-0 | 1.92 | 1.26 | 1.31 | 0.30 | 0.05 | 0.00 | 0.16 | 0.14 | 0.06 | 0.20 | 0.14 | 0.00 | 0.16 | 0.00 |
| Fertilizer + 50 | | | | | | | | | | | | | | |
| Mesh Net | | | | | | | | | | | | | | |
| Retain, %* | | | | | | | | | | | | | | |
| 3-18-18 | 1.65 | 0.62 | 0.27 | 0.16 | 0.19 | 0.13 | 0.15 | 0.54 | 0.24 | 0.05 | 0.03 | 0.09 | 0.12 | 0.05 |
| Fertilizer + 50 | | | | | | | | | | | | | | |
| Mesh Net | | | | | | | | | | | | | | |
| Retain, %* | | | | | | | | | | | | | | |
| 6-24-6 | 2.42 | 1.87 | 1.28 | 0.32 | 0.35 | 0.19 | 0.43 | 0.46 | 0.43 | 0.62 | 0.20 | 0.22 | 0.45 | 0.55 |
| Fertilizer + 50 | | | | | | | | | | | | | | |
| Mesh Net | | | | | | | | | | | | | | |
| Retain, %* | | | | | | | | | | | | | | |

### Example 6

Reference Example 63 as indicated in Table 13 was prepared in the same manner as in Examples 50-51. The Reference Example, along with the Examples 64-71 in Tables 14-15 were tested for fertilizer compatibility as indicated in Table 16.

TABLE 13

| | 64 | 65 | 66 | 67 |
|---|---|---|---|---|
| Imidacloprid | 43.30 | 43.30 | 43.30 | 43.30 |
| Norlig 11 D | 4.00 | 4.00 | | |
| Diwatex S-3 | | | 4.00 | 4.00 |
| Glycerin | 14.00 | 14.00 | 14.00 | 14.00 |
| Aluminum Oxide C | 0.40 | 0.40 | 0.40 | 0.40 |
| Attagel 50 | 0.30 | 0.30 | 0.30 | 0.30 |
| Zinc sulfate | | 0.50 | | 0.50 |
| Potassium chloride | 4.00 | | 4.00 | |
| Hi-Sil 233 | 0.30 | 0.30 | 0.30 | 0.30 |
| Proxel GXL | 0.20 | 0.20 | 0.20 | 0.20 |
| Deionized Water | 33.50 | 37.00 | 33.50 | 37.00 |
| Total | 100 | 100 | 100 | 100 |
| Specific Gravity, g/ml | 1.295 | 1.256 | 1.284 | 1.242 |
| Viscosity, cps, set | 11840 | 4320 | 5480 | 19640 |
| Viscosity, cps, stirred | 7300 | 712 | 436 | 424 |

TABLE 14

| | 68 | 69 | 70 | 71 |
|---|---|---|---|---|
| Imidacloprid | 43.88 | 43.88 | 43.88 | 43.88 |
| Borresperse NA | 3.5 | 3.5 | 3.5 | 3.5 |
| Morwet D425 | 0.5 | 0.5 | 0.5 | 0.5 |
| Glycerine | 14 | 14 | 14 | 14 |
| Aluminum Oxide C | 0.4 | 0.4 | 0.4 | 0.4 |
| Attagel 50 | 0.3 | 0.3 | 0.3 | 0.3 |
| Potassium Chloride | 3 | | | |
| Sodium Chloride | | 3 | | |
| Zinc Sulfate | | | 0.5 | |
| Magnesium Chloride | | | | 0.5 |
| Proxel GXL | 0.1 | 0.1 | 0.1 | 0.1 |
| Hi-Sil 233 | 0.3 | 0.3 | 0.3 | 0.3 |
| Antifoam 8830 FG | 0.3 | 0.3 | 0.3 | 0.3 |
| Water | 33.72 | 33.72 | 36.22 | 36.22 |
| Total | 100 | 100 | 100 | 100 |
| Specific Gravity, | 1.281 | 1.286 | 1.261 | 1.254 |
| g/ml | | | | |
| Viscosity, cps, set | 728 | 604 | 180 | 400 |
| Viscosity, cps, | 188 | 176 | 60 | 128 |
| stirred | | | | |

TABLE 16

| 43% | | | | | | | | | |
|---|---|---|---|---|---|---|---|---|---|
| Formulations | 63 | 64 | 65 | 66 | 67 | 68 | 69 | 70 | 71 |
| 342 ppm Hard | 0 | 0 | 0 | 0 | 0 | 0.04 | 0.07 | 0.02 | 0.00 |
| water + 50 | | | | | | | | | |
| Mesh Net | | | | | | | | | |
| Retain, % | | | | | | | | | |
| 10-34-0 | 1.65 | 0.94 | 0.01 | 0.70 | 0.17 | 0.83 | 0.50 | 0.85 | 0.81 |
| Fertilizer + 50 | | | | | | | | | |
| Mesh Net | | | | | | | | | |
| Retain, % | | | | | | | | | |
| 6-24-6 | 0.43 | 0.05 | 0.16 | 0.69 | 0.14 | 0.29 | 0.29 | 0.40 | 0.75 |
| Fertilizer + 50 | | | | | | | | | |
| Mesh Net | | | | | | | | | |
| Retain, % | | | | | | | | | |

Formulation Diluted with Water 1:1 Beforehand

| | | | | | | | | | |
|---|---|---|---|---|---|---|---|---|---|
| 10-34-0 | 1.02 | 0 | 0 | 0 | 0 | 0.48 | 0.21 | 0.18 | 0.08 |
| Fertilizer + 50 | | | | | | | | | |
| Mesh Net | | | | | | | | | |
| Retain, % | | | | | | | | | |
| 6-24-6 Fertilizer + 50 | 0.6 | 0.024 | 0.032 | 0.014 | 0.011 | 0.16 | 0.13 | 0.29 | 0.10 |
| Mesh Net | | | | | | | | | |
| Retain, % | | | | | | | | | |

### Exmple 7

Preparation of Example 68 in industrial batch scale. An industrial batch of high concentratioin Imidacloprid suspension concentrate was manufactured as follows. Charged to a mixing vessel of 150 gal. capacity in the order listed, water, 246 lb; Borresperse NA, 30 lb; Morwet D425, 4.3 lb; glycerin, 120.5 lb; Aluminum oxide, 3.44 lb; Attagel 50, 2.6 lb; Hi-Sil 233, 2.6 lb; Proxel GXL, 0.9 lb; and Antifoam 8830 FG, 2.6 lb. The ingredients were then well mixed followed by addition of 377 lb Imidacloprid technical. Wet milling was carried out in a bead mill with 5 liter chamber. Zirconium beads of 1.4 mm diameter were used. The ground formulation mill base was then discharged after the particle size reached <50% volume average of 2.75 microns. To the recovered mill base (762 lb) was added 43.5 lb of water, 25 lb potassium chloride and 0.87 lb blue dye to complete the final formulation. The product afforded the following properties, specific gravity of 1.282, set viscosity, 728 cps and stirred viscosity, 188 cps. The initial viscosity was surprisingly low; however, given time the viscosity was found to have increased after 4 weeks at room temperature to a set viscosity of 1040 cps, stirred viscosity 80 cps; another sample after 4 weeks at 40 C provided a set viscosity of 3130 cps; stirred viscosity, 112 cps).

### Example 8

The product of Example 7 was mixed with various liquid fertilizers under laboratory conditions. 500 mL of the following liquid fertilizers were placed into a clear container:local tap water; 7-30-3; 7-26-0-8; and 10-34-0. Admire 2F and Example 68 were added at rates below for a 20 grams per acre application of imidacloprid to the soil. This represented about 3.1 mL of Admire 2F per 500 mL fertilizer and about 1.3 mL of Example 68 per 500 mL fertilizer. Combinations were inverted four times and left to stand for 10 minutes. Observations were made immediately after inversion and after standing for 10 minutes. If combinations were not in solution after 10 minutes, an additional 250 mL of water was added to aid the product's entry into solution. Combination was inverted an additional four times and observations were taken after 10 minutes of standing. The following results were obtained.

TABLE 17

| (mixing with | | +10 minutes | +10 min. + 250 mL |
|---|---|---|---|
| water) | Initial mixing | standing | water |
| Admire 2F | Mixed into | Normal product | Not necessary |
| | solution | settling | |
| | No scum layer | Foam | |
| | No initial | | |
| | precipitates | | |
| | Foam | | |
| Example 16 | Mixed into | Normal product | -Not necessary |
| | solution | settling | |
| | No scum layer | No foam | |
| | No initial | | |
| | precipitates | | |
| | No foam | | |

TABLE 18

| Mix with | | +10 minutes | +10 min. + 250 mL |
|---|---|---|---|
| 7-30-3 | Initial mixing | standing | water |
| Admire 2F | Mixed into | Normal product | Addition of water |
| | suspension of | settling | did not change |
| | suspended bodies | | mixture |
| | No scum layer nor | | |
| | initial precipitates | | |
| | No foam | | |
| Example 68 | Mixed into | Normal product | Addition of water |
| | suspension of | settling | did not change |
| | suspended bodies | | mixture |
| | No scum layer | | |
| | No initial | | |
| | precipitates | | |
| | No foam | | |

TABLE 19

| Mix with | | +10 minutes | +10 min. + 250 mL |
|---|---|---|---|
| 7-26-0-8 | Initial mixing | standing | water |
| Admire 2F | Mixed into | Suspended | — |
| | suspension of | bodies dissolved | |
| | suspended bodies | into a true | |
| | No scum layer | solution | |
| | No initial | No settling | |
| | precipitates | | |
| | No foam | | |
| Example 68 | Mixed into | Suspended | — |
| | suspension of | bodies dissolved | |
| | suspended bodies | into a true | |
| | No scum layer | solution | |
| | No initial | No settling | |
| | precipitates | | |
| | No foam | | |

TABLE 20

| Mix with | | +10 minutes | +10 min. + 250 mL |
|---|---|---|---|
| 10-34-0 | Initial mixing | standing | water |
| Admire 2F | Mixed into | Product settled | Addition of water |
| | suspension of | out | did not change |
| | suspended bodies | | mixture |
| | Scum layer | | |
| | No initial | | |
| | precipitates | | |
| | No foam | | |
| Example 68 | Mixed into | Product settled | Addition of water |
| | suspension of | out | did not change |
| | suspended bodies | | mixture |
| | No scum layer | | |
| | No initial | | |
| | precipitates | | |
| | No foam | | |

TABLE 21

| Mix | | +10 minutes | +10 min. + 250 mL |
|---|---|---|---|
| with 5-17-0 | Initial mixing | standing | water |
| Admire 2F | Mixed into | Product settled | — |
| | suspension of | out | |
| | suspended bodies | | |
| | Scum layer | | |
| | No precipitates | | |
| | No foam | | |
| Example 68 | Mixed into a true | Normal product | — |
| | solution | settling | |
| | No scum layer | | |
| | No precipitates | | |
| | No foam | | |

TABLE 22

| | | +10 minutes | +10 min. + 250 mL |
|---|---|---|---|
| | Initial mixing | standing | water |
| Admire 2F | Mixed into | Product settled | — |
| | suspension of | out | |
| | suspended bodies | | |
| | No scum layer | | |
| | No precipitates | | |
| | No foam | | |
| AMSI 302 | Mixed into a true | Normal product | — |
| 550SC | solution | settling | |
| | No scum layer | | |
| | No precipitates | | |
| | No foam | | |

We Claim:

1. A fluid thixotropic composition comprising:
(a) a compound of formula (I) 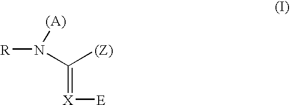
wherein
R is hydrogen, acyl, alkyl, aryl, aralkyl, heteroaryl or heteroarylalkyl;
A is hydrogen, acyl, alkyl, aryl, or a bifunctional group which is linked to Z;
E is NO₂, CN, or a halogenoalkylcarbonyl group;
X is —CR′═ or ═N—, wherein R′ is hydrogen or a bifunctional group linked to Z;
Z is alkyl, —OR″, —SR″, —NR″R″ or Z is a group linked to (i) the radical A; or (ii) the radical X or (iii) both A and X;
provided that when E is CN, Z is not methyl and R is not a (6-chloro-3-pyridyl)methyl 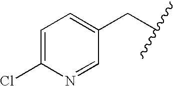
radical;
(b) a metal lignosulfate salt;
(c) a water soluble salt of a strong acid; and
(d) water;
wherein the compound is in the form of particles of sufficiently small average diameter to be effectively dispersed in the composition and wherein the metal lignosulfate salt and water soluble salt are combined in amounts effective to disperse the particles in the water.

2. The composition of claim 1 wherein the mixture comprises particles of average diameter from about 0.1 mm to 6 mm.

3. The composition of claim 1 wherein the mixture further comprises (e) a diluent.

4. The composition of claim 1 wherein the mixture further comprises (f) a surfactant.

5. The composition of claim 1 which is substantially free of (f) a surfactant.

6. The composition of claim 1 wherein the mixture further comprises a (g) lubricant

7. The composition of claim 1 which is substantially free of an anti-foaming agent.

8. The composition of claim 1 wherein the insecticide and metal lignosulfate salt are present at a ratio of from about 60:1 to about 1:10.

9. The composition of claim 1 wherein the metal lignosulfate salt and the halide salt are present in a ratio of from about 2:1 to about 1:20.

10. The composition of claim 2 wherein the particles are from about 2 to 4 microns average diameter.

11. The composition of claim 1 wherein the metal lignosulfate salt is an alkali metal lignosulfate salt or an alkaline earth metal lignosulfate salt.

12. The composition of claim 1 wherein the water soluble salt of a strong acid is LiCl, NaCl, KCl or MgCl₂.

13. The composition of claim 3 wherein the diluent is a polyhydroxylated alkane.

14. The composition of claim 3 wherein the diluent is 1,2,3-propanetriol.

15. The composition according to claim 1 wherein the composition in use forms an agriculturally acceptable admixture with a liquid fertilizer composition.

16. The composition of claim 15 wherein the liquid fertilizer comprises from about I to about 50% by weight of a nitrogen component.

17. The composition of claim 15 wherein the liquid fertilizer comprises from about 1 to about 50% by weight of a potassium component.

18. The composition of claim 15 wherein the liquid fertilizer comprises from about 1 to about 50% by weight of a phosphorus component.

19. The composition of claim 15 wherein the fertilizer is a corn-plant and/or corn-seed compatible fertilizer.

20. The composition of claim 15 wherein the fertilizer is a grass-seed and/or grass-plant compatible fertilizer.

21. The composition of claim 1 wherein the compound is:

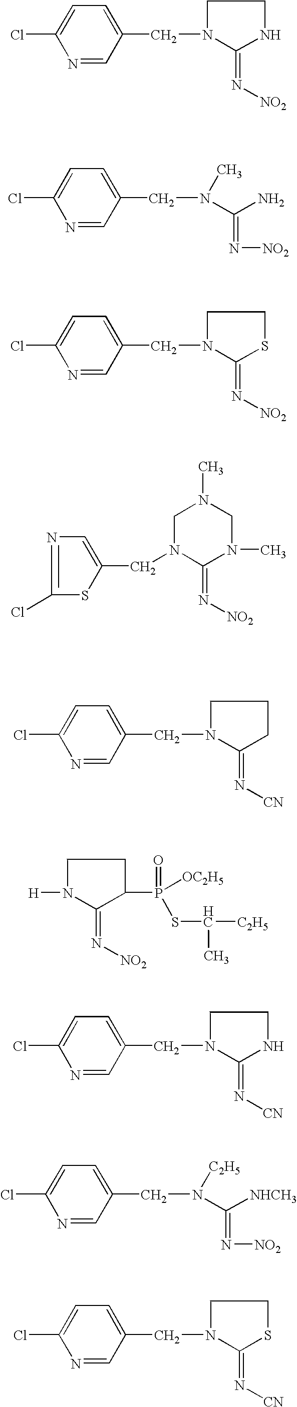

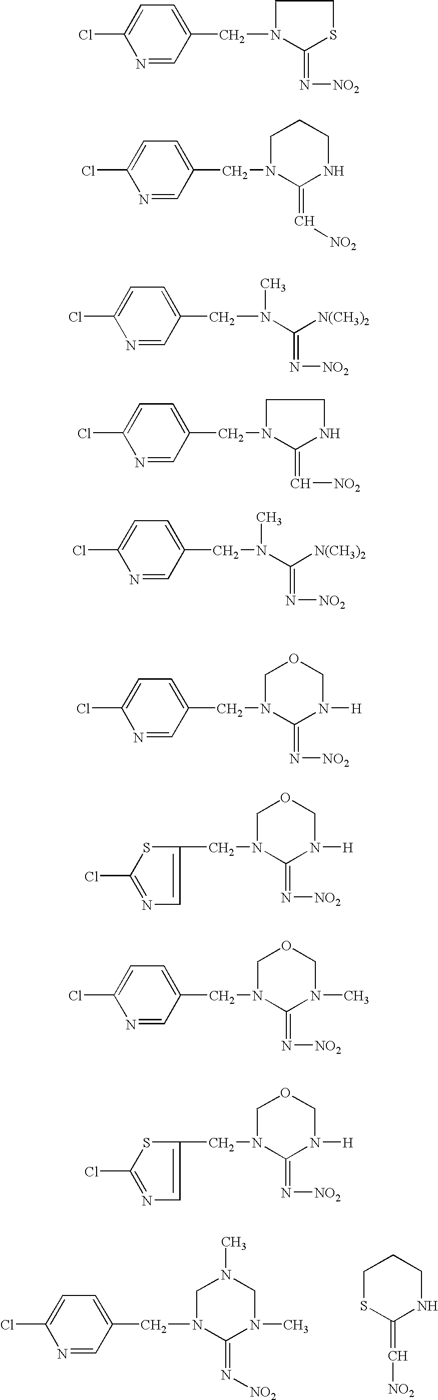

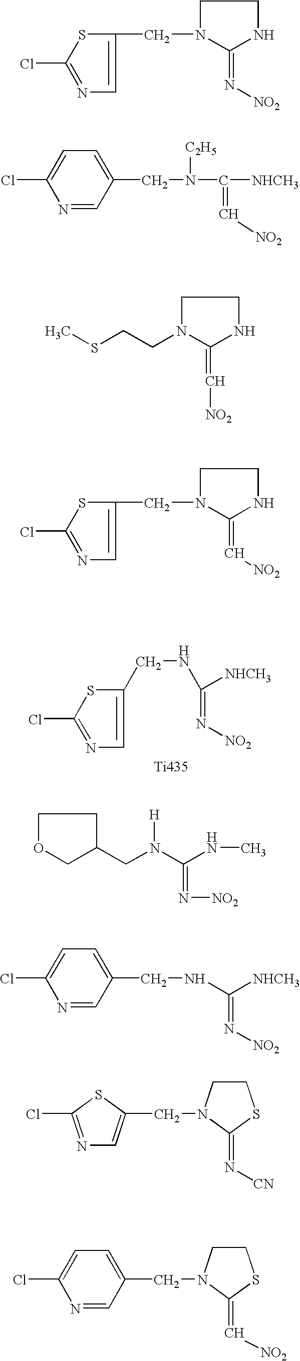

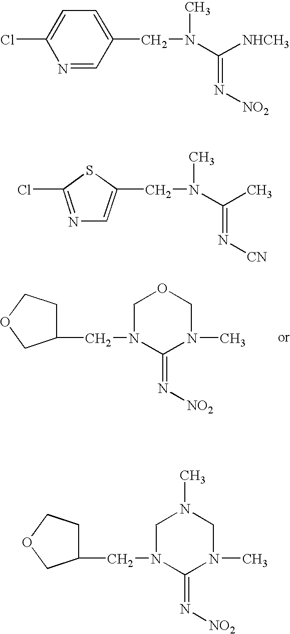

22. The composition of claim 1 wherein the compound is imidacloprid.

23. The composition of claim 1 wherein the compound is thiamethoxam.

24. The composition of claim 1 wherein the compound is thiacloprid.

25. The composition of claim 1 wherein the compound is clothianidin.

26. The composition of claim 1 wherein the compound is nitenpyram.

27. The composition of claim 1 wherein the compound is nithiazine.

28. The composition of claim 1 wherein the compound is dinotefuran.

29. A method of controlling insects which method comprises:
(a) providing a composition according to claim 1; and
(b) applying the composition to a locus where insects are or are expected.

30. The method according to claim 29 wherein the composition is admixed with a liquid fertilizer composition before application to the locus.

31. A product comprising a composition according to claim 1 and an agriculturally acceptable liquid fertilizer for simultaneous, separate or sequential use in the control of pests at a locus.
